(19) United States
(12) Patent Application Publication
(10) Pub. No.: US 2025/0104993 A1
(43) Pub. Date: Mar. 27, 2025

(54) DEUTERIUM GAS GENERATOR AND DEVICES FOR CONSERVATION THEREOF

(71) Applicant: Thermo Finnigan LLC, San Jose, CA (US)

(72) Inventors: Michael A. Senko, San Jose, CA (US); Scott Quarmby, Round Rock, TX (US)

(21) Appl. No.: 18/473,049

(22) Filed: Sep. 22, 2023

(51) Int. Cl. H01J 49/42; H01J 49/00; H01J 49/06

(52) U.S. Cl. CPC H01J 49/4225; H01J 49/0031; H01J 49/062

(57) ABSTRACT

An analytical instrument. The analytical instrument includes of one or both of an ion trap or a collision cell. One or both of the ion trap or collision cell is filled with deuterium gas.

### BACKGROUND

Ion traps and collision cells are often used in mass spectrometry, examples of which are well known in the art, see for example, U.S. Pat. No. 7,180,057 and Ser. No. 18/047,801, which are hereby incorporated by reference. Typically, collision cells use nitrogen or argon because heavier gases are preferred for breaking apart ions. There are cases where hydrogen is used such as the reaction cell in an ICP-MS. Interestingly the collision cell can act as a collision or reaction cell depending on the gas which is introduced.

### SUMMARY

The present disclosure relates to analytical instruments comprising one or both of an ion trap or a collision cell, where one or both of the ion trap or the collision cell is filled with a deuterium gas, in particular, mass spectrometers comprising one or both of an ion trap or a collision cell, and methods of using such instruments. The present disclosure also relates to the use of deuterium as a gas in one or both of an ion trap or collision cell. It should be understood that “one or both of an ion trap or a collision cell” encompasses an ion trap only, a collision cell only, and both an ion trap and a collision cell. It should be understood that “one or both of the ion trap or the collision cell is filled with deuterium gas” encompasses only an ion trap having deuterium gas therein (whether or not a collision cell is also present), only a collision cell having deuterium gas therein (whether or not an ion trap is also present), and both an ion trap having deuterium gas therein and a collision cell having deuterium gas therein.

Chromatography can be used as an analytical tool, feeding its output into a detector that reads the contents of the mixture. It can also be used as a purification tool, separating the components of a mixture for use in other experiments or procedures. Typically, analytical chromatography uses a much smaller quantity of material than chromatography meant to purify a mixture or extract specific components from it.

Chromatography may use liquid or gas as the mobile phase, and when used as an analytical tool are often connected to mass spectrometers.

Mass spectrometry can be used to perform detailed analysis on samples. It can provide both qualitative (e.g., is X present) and quantitative (e.g., how much X is present) data for a large number of compounds in a sample. These capabilities have been used for a wide variety of analysis, such as to test for drug use, determine pesticide residues in food, monitor water quality, and the like.

A typical mass spectrometer utilized for GC-MS, LC-MS, IC-MS, or ICP-MS generally requires some means of high vacuum pumping. Such pumping helps remove permanent gases (e.g., nitrogen and oxygen) as well as carrier gases (e.g., helium, hydrogen, or nitrogen) in order to achieve appropriate mean free path lengths for the transmission of ion beams. Removal of such gases additionally prevents unwanted ion-molecule reactions, collisional scattering, oxidation of source components and high voltage breakdown. And such pumping helps maintain a high vacuum environment to remove introduced contaminants which would otherwise result in adverse analytical performance.

Ion traps utilize a background or buffer gas to induce collisional damping and thus increase mass resolution and sensitivity. Different types of ion traps use different gases depending on the mission. Heavier gases are generally preferred because they collisionally damp ions and improve trapping efficiency and fragmentation efficiency. However, heavy gases cause issues when ions are ejected in the case of linear or 3D quadrupole ion traps. A lower molecular weight buffer gas helps prevent significant momentum changes, such as smaller displacement and velocities, upon collision with an analyte ion, minimizing the loss of trapped ions. Therefore, helium is often used as a compromise in molecular weight.

Light buffer gases provide large performance gains for ion trap mass spectrometers and collision cells, such as quadrupole ion trap mass spectrometers.

Recently, the most commonly used gas has been helium, but helium can be difficult and costly to obtain. Hydrogen can be used as a substitute buffer gas and has been found to work well for the generation of mass spectra. However, hydrogen (H₂) does not work well as a collision partner for dissociation, since it is too light to effectively transfer translational energy into internal energy. One solution is to mix the H₂ with a partial pressure of a heavier gas, such as nitrogen (N₂) or Ar, but mixing in a consistent fashion can be challenging. Accordingly, there is a need in the art for a lighter buffer gas that can be used effectively as an alternate gas to helium and hydrogen and addresses at least some of the abovementioned issues.

The present inventors have found that deuterium can surprisingly be used as an effective substitute for helium as a gas in mass spectrometry applications where deuterium has the advantage of being significantly dryer than helium which may reduce ion/molecule interactions and/or the formation of erroneous ions formation.

In one aspect, the disclosure provides an analytical instrument. The analytical instrument includes one or both of an ion trap or a collision cell. One or both of the ion trap or the collision cell is filled with deuterium gas.

In another aspect, the disclosure provides a method of using a gas in an analytical instrument. The method comprises using a deuterium gas as a primary gas in one or both of an ion trap or a collision cell.

In yet another aspect, the disclosure provides a method of mass spectrometry. The method comprises generating first ions, processing the first ions in one or both of an ion trap or a collision cell, and analysing the first ions. One or both of the ion trap or the collision cell is filled with a deuterium gas.

Other aspects of the disclosure will become apparent by consideration of the detailed description and accompanying drawings.

### BRIEF DESCRIPTION OF THE DRAWINGS

FIG. 1 is a schematic diagram of an analytical instrument.

FIG. 2 is a schematic diagram of a mass spectrometer.

FIG. 3 is a schematic diagram of an ion trap.

### DETAILED DESCRIPTION

Before any implementations of the disclosure are explained in detail, it is to be understood that the disclosure is not limited in its application to the details of construction and the arrangement of components set forth in the following description or illustrated in the following drawings. The disclosure is capable of other implementations and of being practiced or of being carried out in various ways.

The present inventors have found that deuterium can surprisingly be used as an effective substitute for helium as a gas in mass spectrometry applications where deuterium has the advantage of being significantly dryer than helium which may reduce ion/molecule interactions and/or the formation of erroneous ions formation.

Thus, the present disclosure provides an analytical instrument comprising one or both of an ion trap or collision cell, wherein one or both of the ion trap or collision cell is filled with deuterium gas. In the analytical instrument of the disclosure, the deuterium gas may be present/used in order to provide various functions. For example, the deuterium gas may be present/used in order to carry samples through the analytical instrument as a carrier gas.

Additionally, or alternatively, the deuterium gas may be present/used for collisional damping. That is the deuterium gas may be used in ion traps to capture incoming ions and/or used in collision cells and other ion guides to reduce the energy and positional spread of the ion beam.

Additionally, or alternatively, the deuterium gas may be present/used for fragmentation (collision induced dissociation) in one or both of the ion trap or collision cell. Additionally, or alternatively, the deuterium gas may be present/used in order to induce reactions with one or both of the ion trap or the collision cell, such as ICP-MS. Additionally, or alternatively, the deuterium gas may act as/be used as a buffer gas.

Thus, the present disclosure may provide an analytical instrument comprising one or both of an ion trap or collision cell, wherein the ion trap and/or collision is filled with deuterium gas as a carrier gas, a collisional damping gas, a fragmentation gas, a reactional gas and/or a buffer gas.

There are three forms of the element hydrogen consisting of protium which is the “normal” isotope of hydrogen which has been traditionally employed for carrier gas use, the other forms of hydrogen being the stable isotope deuterium and the radioactive isotope tritium. All of these have very similar chemistry but differ in mass due to the number of neutrons contained in the nucleus. All are also diatomic gas species, that is to say they exist under normal states of temperature and pressure as molecules comprising two atoms. Although these atoms may combine in various combinations such as protium-deuterium, deuterium-tritium and protium-tritium, unless otherwise noted herein, the term “deuterium” will refer to the isotopically pure diatomic deuterium-deuterium species while “hydrogen” will refer to the isotopically pure protium-protium species.

As noted above, one or both of the ion trap or the collision cell in the analytical instrument is filled with deuterium gas.

As used herein, the term “filed” is intended to mean that one or both of the ion trap or the collision cell contains gas from about 1 m Torr to about 200 mTorr, such as from about 20 mTorr to about 140 mTorr or from about 40 mTorr to about 100 mTorr.

As used herein, the term “deuterium gas” is intended to mean a gas that comprises at least 51% deuterium, preferably at least 75%, such as at least 90% or at least about 99% deuterium. For example, the deuterium gas may comprise from about 51% to about 100% deuterium, such as from about 75% to about 100%. Thus, one or both of the ion trap or the collision cell may contain a gas comprising at least 51% deuterium at a pressure of from about 1 mTorr to about 100 mTorr, or such combinations as derived from the above combinations.

Background gas (such as air or nitrogen) may typically be present below 1×10\hat{ }−5 Torr.

The analytical instrument may be any instrument that comprises one or both of an ion trap or collision cell. However, it may be preferred that the analytical instrument comprises a mass spectrometer. That is, the analytical instrument may be a mass spectrometer or may be a mass spectrometer that is connected to/used in combination with other analytical instruments, such as a chromatography system. In a preferred aspect, the analytical instrument may be a mass spectrometer connected to/used in combination with a chromatography system. Where the analytical instrument is connected to/used in combination with a chromatography system, the chromatography system may be a gas chromatography system or a liquid chromatography system. In some aspects, the ion trap may be quadrupole ion trap or a mass analyzer. The deuterium gas may be provided to one or both of the ion trap or the collision cell by any suitable mean. It may be preferred that the deuterium gas may be provided by a cylinder of deuterium gas. Alternatively, the deuterium gas may be provided by a deuterium generator.

In the analytical instrument, the deuterium gas may typically be provided to one or both of the ion trap or the collision cell at a pressure of at least 0.1 mTorr. For example, the deuterium gas may be provided at a pressure of about 1 m Torr to about 200 mTorr, such as from about 20 mTorr to about 140 mTorr or from about 40 mTorr to about 100 mTorr.

The present disclosure also provides a method of using deuterium gas as the primary gas in an ion trap (such as a quadrupole ion trap) and/or a collision cell.

As noted above, the deuterium gas used in one or both of the ion trap or the collision cell may be used as a carrier gas, a collisional damping gas, a fragmentation gas, a reactional gas and/or a buffer gas.

As used herein, the term “primary gas” is intended to mean that the specified gas (i.e. deuterium) makes up the largest percentage of the gas. That is, in the method of the disclosure, the deuterium gas may comprise at least 51% deuterium, preferably at least 75%, such as at least 90% or at least about 99% deuterium. For example, the deuterium gas may comprise from about 51% to about 100% deuterium, such as from about 75% to about 100% and may typically be provided to one or both of the ion trap or the collision cell at a pressure of at least 0.1 mTorr. For example, the deuterium gas may be provided at a pressure of about 1 m Torr to about 200 mTorr, such as from about 20 mTorr to about 140 mTorr or from about 40 mTorr to about 100 mTorr.

In the method of the disclosure, one or both of the ion trap or the collision cell may preferably be in a mass spectrometer used in combination with a chromatography system. The chromatography system may be a gas chromatography system or a liquid chromatography system as defined previously.

In the method of the disclosure, the deuterium gas may be provided via a deuterium gas generator system or via a compressed cylinder of deuterium gas.

The present disclosure also provides a method of mass spectrometry comprising: (i) generating first ions; (ii) processing the first ions in one or both of an ion trap or a collision cell, wherein one or both of the ion trap or the collision cell is filled with a deuterium gas; and (iii) analyzing the first ions or second ions derived from the first ions.

In the method of the disclosure defined herein, the deuterium gas may comprise at least 51% deuterium, preferably at least 75%, such as at least 90% or at least about 99% deuterium. For example, the deuterium gas may comprise from about 51% to about 100% deuterium, such as from about 75% to about 100% and may typically be provided to one or both of the ion trap or the collision cell at a pressure of at least 0.1 mTorr. For example, the deuterium gas may be provided at a pressure of about 1 m Torr to about 200 mTorr, such as from about 20 mTorr to about 140 mTorr or from about 40 mTorr to about 100 mTorr.

In the method of the disclosure, processing the first ions may comprise collisionally cooling the first ions.

The method may further comprise deriving second ions from the first ions; and analysing the second ions. Alternatively, processing the first ions may comprise fragmenting the first ions by colliding them with the collision gas to produce fragment ions, and the analysing comprises analysing the fragment ions.

Alternatively, processing the first ions may comprise reacting the first ions with the deuterium gas to produce secondary ions, and the analysing comprises analysing the secondary ions.

The analysing of the fragmented ions or secondary ion may be done within one or both of the ion trap or the collision cell or may be done by ejecting the fragment ions or secondary ions sending them to an analysis device.

Alternatively, processing the first ions may comprise fragmenting the first ions by colliding them with the collision gas to produce fragment ions, and ejecting the fragment ions to be further reacted and/or fragmented and/or analysed. Alternatively, processing the first ions may comprise reacting the first ions with the deuterium gas to produce secondary ions, and ejecting the secondary ions to be further reacted and/or fragmented and/or analysed.

The above noted and various other aspects of the present disclosure will become apparent from the following description which is given by way of example only and with reference to the accompanying drawings, not necessarily drawn to scale.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. Furthermore, one skilled in the art can readily appreciate that the specific sequences in which methods are presented and performed are illustrative and it is contemplated that the sequences can be varied and still remain within the spirit and scope of the various embodiments disclosed herein.

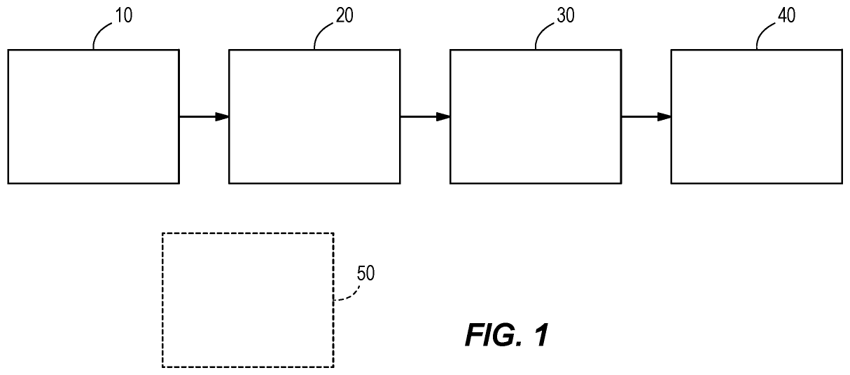

FIG. 1 illustrates schematically an analytical instrument. In the non-limiting example of FIG. 1 a mass spectrometer is illustrated. However, it will be appreciated that any analytical instrument comprising one or both of an ion trap or a collision cell may be used.

Various aspects of the exemplary mass spectrometers described herein are similar to those disclosed by U.S. Pat. No. 10,607,824 to Thermo Finnigan LLC, U.S. Pat. No. 7,230,232 to Thermo Fisher Scientific (Bremen) GmbH, expressly incorporated herein for all purposes by this reference.

As shown in FIG. 1, the instrument includes an ion source 10, a ion trap 20, a collision cell 30, and a mass analyser 40.

The ion source 10 is configured to generate ions from a sample. The ion source 10 may be coupled to a chromatographic separation device (not shown) such as a liquid chromatography (LC) separation device, a gas chromatography (GC) separation device, or a capillary electrophoresis separation device, such that the sample which is ionised in the ion source 10 comes from the separation device. The ion source 10 can be any suitable ion source, such as an electrospray ionisation (ESI) ion source, an atmospheric pressure ionisation (API) ion source, a chemical ionisation ion source, an electron impact (EI) ion source, or similar.

The ion trap 20 is arranged downstream of the ion source 10 and is configured to receive ions from the ion source 10. The ion trap 20 is configured to filter the received ions according to their mass to charge ratio (m/z). The ion trap 20 may be configured such that received ions having m/z within an m/z transmission window of the ion trap are onwardly transmitted by the ion trap, while received ions having m/z outside the m/z transmission window are attenuated by the ion trap, i.e. are not onwardly transmitted by the ion trap.

The width and/or the centre m/z of the transmission window may be controllable (variable), e.g. by suitable control of RF and/or DC voltage(s) applied to electrodes of the ion trap 20. Thus, for example, the ion trap 20 may be operable in a transmission mode of operation, whereby most or all ions within a relatively wide m/z window are onwardly transmitted by the ion trap 20, and a filtering mode of operation, whereby only ions within a relatively narrow m/z window (centred at a desired m/z) are onwardly transmitted by the ion trap 20. The ion trap 20 can be any suitable type of ion trap, such as a quadrupole ion trap.

The collision cell 30 is arranged downstream of the ion trap 20, and is configured to receive most or all ions transmitted by the ion trap 20. The collision cell 30 may be configured to selectively fragment some or all of the received ions, i.e. so as to produce fragment ions. The collision cell 30 may be operable in a fragmentation mode of operation, whereby most or all received ions are fragmented so as to produce fragment ions (which may then be onwardly transmitted from the collision cell 30), and a non-fragmentation mode of operation, whereby most or all received ions are onwardly transmitted without being (deliberately) fragmented. It would also be possible for a non-fragmentation mode of operation to be implemented by causing ions to bypass the collision cell 30. The collision cell 30 may also be operable in one or more intermediate modes of operation, e.g. whereby the degree of fragmentation is controllable (variable). The collision cell 30 can also be operable in higher order (MSⁿ) fragmentation modes of operation, e.g. whereby fragment ions are further fragmented one or more times by the collision cell 30.

The collision cell 30 can be any suitable type of collision cell, such as for example a collision induced dissociation (CID) collision cell, an electron induced dissociation (EID) collision cell, a photodissociation collision cell, and so on. Numerous other types of fragmentation are possible.

In some embodiments, the collision cell 30 is a collision induced dissociation (CID) collision cell. Thus, the collision cell may include a collision cell which may be filled with a collision gas, e.g. maintained at a relatively high pressure. Ions may be selectively fragmented in the collision cell by controlling (varying) the kinetic energy with which ions are caused to enter the collision cell. In a fragmentation mode of operation, ions may be accelerated so that they enter the collision cell with a relatively high kinetic energy, which may cause most or all of the accelerated ions to fragment. In a non-fragmentation mode of operation, ions may be caused to enter the collision cell with a relatively low kinetic energy, which may be insufficient to cause most or all of the ions to fragment. In intermediate modes, ions may be caused to enter the collision cell with intermediate kinetic energies.

Deuterium gas is introduced into the ion trap or collision cell through a tube or orifice. The deuterium gas pressure is controlled using a pressure or flow controller. The pressure in the cell can be measured with a pressure sensing device such as a Pirani gauge, thermocouple gauge, capacitance manometer, ionization gauge, or some other means. That pressure measurement may be used to provide feedback to the pressure or flow controller to closed loop control the pressure. Or, the conductance out of the cell may be characterized a prior and a fixed flow of gas be introduced. The flow controller may consist of a pressure controller and a fixed restriction such as a frit or capillary. Alternatively, a mass flow controller can be used.

The mass analyser 40 is arranged downstream of the collision cell 30 and is configured to receive ions from the collision cell 30. Thus, the mass analyser 40 may receive unfragmented precursor ions or fragment ions, depending on the mode of operation of the collision cell 30. The mass analyser 40 is configured to analyse the received ions so as to determine their mass to charge ratio (m/z) and/or mass, i.e. to produce a mass spectrum of the ions. The mass analyser 40 can be any suitable type of mass analyser, such as an ion trap mass analyser, an electrostatic orbital trap mass analyser (such as an Orbitrap™ FT mass analyser as made by Thermo Fisher Scientific) or a time-of-flight (ToF) mass analyser such as a multi-reflecting time-of-flight (MR-ToF) mass analyser.

It should be noted that FIG. 1 is merely schematic, and that the instrument can, and in embodiments does, include any number of one or more additional components. For example, the instrument may include one or more ion transfer stage(s) arranged between any of the illustrated components, e.g. including an atmospheric pressure interface and/or one or more ion guides, lenses and/or other ion optical devices configured such that some or all of the ions can be transmitted appropriately through the instrument. The ion transfer stage(s) may include any suitable number and configuration of ion optical devices, for example optionally including one or more ion guides, lenses and/or other ion optical devices.

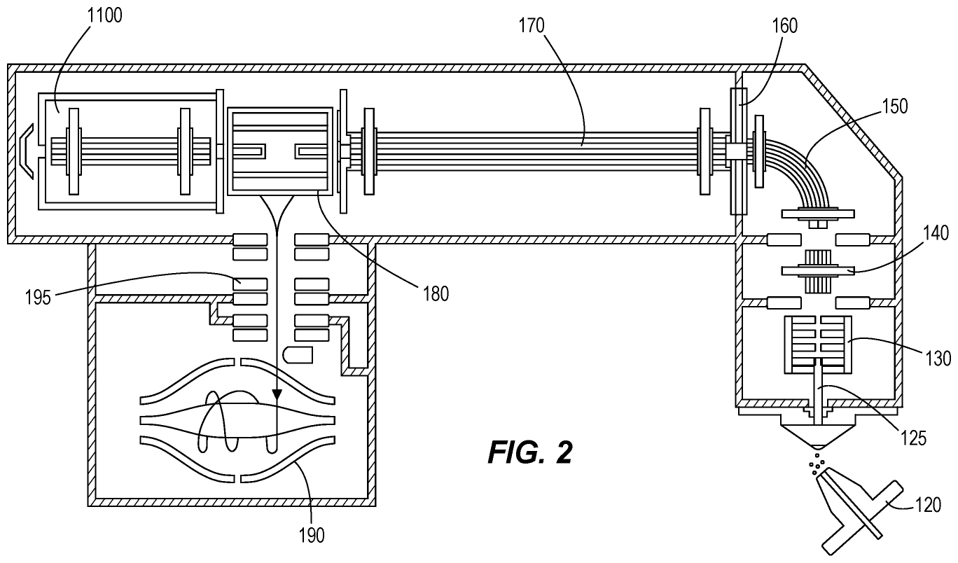

FIG. 2 shows a more detailed schematic arrangement of a mass spectrometer that may be used in the present disclosure.

In FIG. 2, a sample to be analysed is supplied (for example from an autosampler) to a chromatographic apparatus such as a liquid chromatography (LC) column (not shown in FIG. 2). One such example of an LC column is the Thermo Fisher Scientific, Inc., PROSWIFT (RTM) Monolithic Column which offers high performance liquid chromatography (HPLC) through the forcing of the sample carried in a mobile phase under high pressure through a stationary phase of irregularly or spherically shaped particles constituting the stationary phase. In the HPLC column, sample molecules elute at different rates according to their degree of interaction with the stationary phase. For example, a sample molecule may be a protein or a peptide molecule.

The sample molecules thus separated by liquid chromatography are then ionized using an Electro-Spray Ionization (ESI) source 120, which is at atmospheric pressure to form sample ions.

The sample ions generated by the ESI source 120 are transported to an ion trap 180 by ion transportation means of the mass spectrometer 110. According to the ion transportation means, sample ions generated by the ESI source 120 enter a vacuum chamber of the mass spectrometer 110 and are directed by a capillary 125 into an RF-only S lens 130. The ions are focused by the S lens 130 into an injection flatapole 140 which injects the ions into a bent flatapole 150 with an axial field. The bent flatapole 150 guides (charged) ions along a curved path through it whilst unwanted neutral molecules such as entrained solvent molecules are not guided along the curved path and are lost. An ion gate 160 is located at the distal end of the bent flatapole 150 and controls the passage of the ions from the bent flatapole 150 into a transport multipole 170. In the embodiment shown in Figure. 2, the transport multipole 170 is a transport octupole. The transfer multipole 170 guides the analyte ions from the bent flatapole 150 into the ion trap 180.

The ion trap 180 is configured to confine and to cool ions injected into it. The detailed operation and construction of the ion trap 180 will be explained in more detail below. Cooled ions confined in the ion trap 180 may be ejected orthogonally from the ion trap 180 towards the mass analyser 190, or alternatively towards the collision cell 1100.

Where the ions pass continue their path through the ion trap 180 into the collision cell 1100, the transmission, or trapping of ions by the ion trap 180 can be selected by adjusting voltages applied to the end electrodes of the ion trap 180. As such, the ion trap 180 may also effectively operate as an ion guide in the second mode of operation. Alternatively, trapped and cooled ions in the ion trap 180 may be ejected from the ion trap 180 in an axial direction into the collision cell 1100. Such ejection may be controlled by application of suitable voltages to the end electrodes of the ion trap 180.

The collision cell 1100, is in the mass spectrometer of FIG. 2, a higher energy collisional dissociation (HCD) device, to which a collision gas is supplied. Sample ions arriving into the collision cell 1100 collide with the collision gas molecules resulting in fragmentation of the sample ions into fragment ions. These fragment ions may be returned from the collision cell 1100 to the ion trap 180 by an appropriate potential applied to the collision cell 1100 and the end electrodes of the ion trap 180. Fragment ions may be cooled and confined in the extraction trap 180, fragment ions may then be ejected from the extraction trap 180 into the mass analyser 190 or mass analysis. The transport octupole may also be used to mass filter the sample ions prior to their injection into the ion trap 180 and collision cell 1100. As such, the transport octupole 170 may also be a mass resolving octupole.

Although an HOD collision cell 1100 is shown in FIG. 2, other fragmentation devices may be employed instead, employing such methods as collision induced dissociation (CID), electrically captured dissociation (ECD), electrically transferred dissociation (ETD), photo dissociation and so forth.

The mass analyser illustrated in FIG. 2 is an orbital trapping mass analyser 190, the Orbitrap (RTM) Mass Analyser sold by Thermo Fisher Scientific, Inc. The orbital trapping mass analyser 190 is an example of a Fourier transform mass analyser. The orbital trapping mass analyser 190 has an off-centre injection aperture in its outer electrode, and the ions are injected into the orbital trapping mass analyser as coherent packets, through the off-centre injection aperture. Ions are then trapped within the orbital trapping mass analyser by a hyperlogarithmic electrostatic field, and undergo back and forth motion in a longitudinal direction whilst orbiting around the inner electrode. The axial component of the movement of the ion packets in the orbital trapping mass analyser is (more or less) defined as simple harmonic motion, with the angular frequency in the axial direction being related to the square root of the mass-to-charge ratio of given ion species. Thus, over time, ions separate in accordance with their mass-to-charge ratio.

It should be noted that although an orbital trapping mass analyser 190 is shown in FIG. 2, other Fourier transform mass analysers may be employed instead. For example, a Fourier transform ion cyclotron resonance (FTICR) mass analyser may be utilized as a mass analyser. Other types of electrostatic traps can also be used as Fourier transform mass analysers. Fourier transform mass analysers, such as the orbital trapping mass analyser 190 and ion cyclotron resonance mass analyser, may also be used in the disclosure even where other types of signal processing other than Fourier transformation are used to obtain mass spectral information from the transient signal (see for example WO-A-2013/171313, Thermo Fisher Scientific).

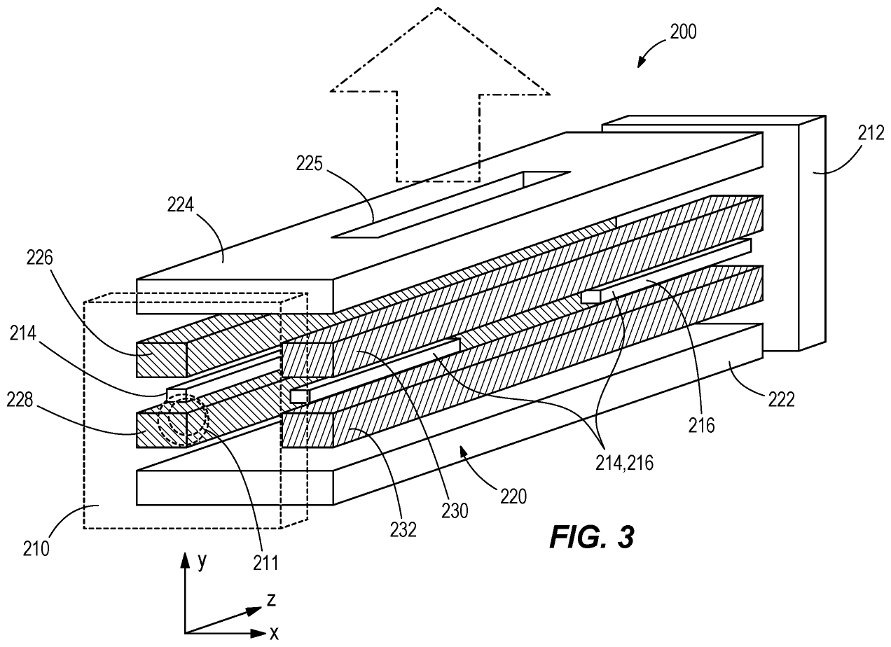

FIG. 3 shows a schematic diagram of an exemplary ion trap 200 that may be used in the present disclosure. The ion trap 200 is of a rectilinear geometry. As such, the ion trap 200 may be used in place of the ion trap 80 shown in the mass spectrometer of FIG. 2. It will be understood that the ion trap 200 may be provided in a linear form, as shown, or alternatively, in a curved form similar to a C-trap.

The ion trap 200 of FIG. 3 comprises a first end electrode 210, a second end electrode 212, a first confining electrode 214, a second confining electrode 216, and a multipole electrode assembly 220. The multipole electrode assembly 220 and the first and second confining electrodes 214, 216 are arranged between the first end electrode 210 and the second end electrode 212. The first end electrode 210 and the second end electrode 212 in this example are in the form of plate electrodes. Each of the first end electrodes 210 and the second end electrode 212 have an ion aperture 211, 213 provided centrally therein for transmission of the ions therethrough. Ions, for example, may enter and/or exit the ion trap 200 axially through the ion aperture 211 in the first end electrode 210 or through the ion aperture 213 in the second end electrode 212.

The multipole electrode assembly 220 shown in FIG. 3 comprises a plurality of elongate electrodes arranged about a central axis to define an elongate ion channel. The multipole electrode assembly includes an elongate push electrode 222 and an opposing elongate pull electrode 224. The elongate push electrode 222 and the elongate pull electrode 224 are spaced apart on opposing sides of the elongate ion channel. The elongate push electrode 222 and the elongate pull electrode 224 are aligned substantially in parallel with each other along the length of the elongate ion channel. As shown in FIG. 3, the elongate push electrode 222 and the elongate pull electrode 224 have substantially flat opposing surfaces. In some embodiments, the opposing surfaces may have a hyperbolic profile. The elongate pull electrode 224 includes a pull electrode aperture 225 at a point along its length. As shown in FIG. 3, the pull electrode aperture 225 is located in a relatively central region of the elongate pull electrode 224. The pull electrode aperture 225 runs through the thickness of the electrode and provides a path for ions to exit the ion trap 200 in a direction generally transverse the axial direction of the ion trap 200. In this way, the ions can be extracted from the ion trap 200 in a direction towards and into the mass analyser 90 as shown in FIG. 2.

The multipole electrode assembly also comprises first elongate split electrodes 226, 228 and second elongate split electrodes 230, 232. The first elongate split electrodes 226, 228 are spaced apart on an opposing side of the elongate ion channel to the second elongate split electrodes 230, 232. The first and second elongate split electrodes 226, 228, 230, 232 are aligned substantially in parallel with each other along the length of the elongate ion channel. The first elongate split electrodes 226, 228 and second elongate split electrodes 230, 232 are spaced apart across the elongate ion channel in a direction which is transverse to the direction in which the elongate push electrode 222, and elongate pull electrode 224 are spaced apart in. As such, the first and second elongate split electrodes 226, 228, 230, 232, the elongate push electrode 222, and the elongate pull electrode 224 define a boundary for the elongate ion channel having a generally rectangular cross-section.

Gas, such as deuterium gas in the present disclosure, is introduced into the ion trap or collision cell through a tube or orifice (not shown).

The descriptions of specific exemplary embodiments of the present disclosure have been presented for purposes of illustration and description. They are not intended to be exhaustive or to limit the disclosure to the precise forms disclosed, and obviously many modifications and variations are possible in light of the above teachings. The exemplary embodiments were chosen and described in order to explain certain principles of the disclosure and their practical application, to thereby enable others skilled in the art to make and utilize various exemplary embodiments of the present disclosure, as well as various alternatives and modifications thereof. It is intended that the scope of the disclosure be defined by the Claims appended hereto and their equivalents.

For the avoidance of doubt, in this specification when we use the term “comprising” or “comprises” we mean that the detection cell or system being described must contain the listed components but may optionally contain additional components. Comprising should be considered to include the terms “consisting of”or “consists of” where the flow-through cell or system being described must contain the listed component(s) only.

For the avoidance of doubt, preferences, options, particular features and the like indicated for a given aspect, feature or parameter of the disclosure should, unless the context indicates otherwise, be regarded as having been disclosed in combination with any and all other preferences, options particular features and the like as indicated for the same or other aspects, features and parameters of the disclosure.

The term “about” as used herein, e.g. when referring to a measurable value (such as an amount or parameter), refers to variations of ±20%, ±10%, ±5%, ±1%, ±0.5%, or, particularly, ±0.1% of the specified amount.

Various features and advantages of the disclosure are set forth in the following claims.

What is claimed is:

1. An analytical instrument, the analytical instrument comprising:
one or both of an ion trap or a collision cell,
wherein one or both of the ion trap or the collision cell is filled with deuterium gas.

2. The analytical instrument of claim 1, wherein the analytical instrument comprises a mass spectrometer.

3. The analytical instrument of claim 1, wherein the ion trap is quadrupole ion trap.

4. The analytical instrument of claim 1, wherein the ion trap is a mass analyzer.

5. The analytical instrument of claim 1, wherein the analytical instrument comprises a chromatography system in combination with a mass spectrometer.

6. The analytical instrument of claim 1, wherein the gas is provided by a cylinder of deuterium gas.

7. The analytical instrument of claim 1, wherein the gas is provided by a deuterium generator.

8. The analytical instrument of claim 1, wherein the gas is provided at a pressure of at least 0.1 mTorr.

9. The analytical instrument of claim 8, wherein the gas is provided at a pressure of about 1 mTorr to about 10 mTorr.

10. A method of using a gas in an analytical instrument, the method comprising:
using a deuterium gas as a primary gas in one or both of an ion trap or a collision cell.

11. The method of claim 10, further comprising using one or both of the ion trap or collision cell in a mass spectrometer in combination with a chromatography system.

12. The method of claim 11, wherein the chromatography system is a gas chromatography system.

13. The method of claim 11, wherein the chromatography system is a liquid chromatography system.

14. The method of claim 12, further comprising providing the deuterium gas via a deuterium gas generator system or via a compressed cylinder of deuterium gas.

15. The method of claim 13, further comprising providing the deuterium gas via a deuterium gas generator system or via a compressed cylinder of deuterium gas.

16. The method of claim 10, wherein the ion trap is a quadrupole ion trap.

17. A method of mass spectrometry, the method comprising:
generating first ions;
processing the first ions in one or both of an ion trap or a collision cell, wherein one or both of the ion trap or the collision cell is filled with a deuterium gas; and
analysing the first ions or second ions derived from the first ions or both.

18. The method of claim 17, wherein processing the first ions comprises collisionally cooling the first ions.

19. The method of claim 17, wherein processing the first ions comprises fragmenting the first ions by colliding them with the deuterium gas to produce fragment ions, and the analysing comprises analysing the fragment ions.

20. The method of claim 17, wherein processing the first ions comprises reacting the first ions with the deuterium gas to produce secondary ions, and the analysing comprises analysing the secondary ions.
